(19) United States
(12) Patent Application Publication
(10) Pub. No.: US 2009/0044218 A1
(43) Pub. Date: Feb. 12, 2009

(54) Font Changing Method for Video Subtitle

(75) Inventor: Ming-Hung Chiang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CYBERLINK CORP., Shindian City (TW)

(21) Appl. No.: 11/836,254

(22) Filed: Aug. 9, 2007

(51) Int. Cl. H04N 5/445

(52) U.S. Cl. 725/37

(57) ABSTRACT

A font changing method for the subtitles of a video is provided. The method utilizes a playback program, which is implemented as a software application or a program embedded in a playback device, to provide a font selection function for the subtitles of the video. Therefore, a user can configure the subtitles easily. This method is used for a DVD that allows separating video streaming and subtitle data. After the playback program has received an activation signal, several steps for changing the font before playing the video are included. Firstly, the playback program receives a subtitle settings signal, and then receives a font selection signal in the settings item. Next, the program accesses a font database built in a storage medium. After that, the program links up to a selected font data. Consequently, the program can play the video after incorporating the font data into the video stream.

### BACKGROUND OF THE INVENTION

1. Field of the Invention

The present invention relates to a method for changing the font of subtitles of a video and, more particularly, to a font changing method applied to a disk in which the video streaming and the subtitle data are separated.

2. Description of Related Art

When a DVD (Digital Versatile Disc) is playing, users can use a menu to configure the settings thereof. For example, the menu has settings for whether or not subtitles are to be shown and what language they should be displayed in, and what language the dialogue is to be played in. However, the settings for the subtitle merely include an option for the languages to be shown, and the languages included in the DVD are stored as image files. When the user makes a selection for the settings, the DVD player appropriately combines the subtitle images with the video streaming on the screen in response to the progress of the DVD. Nevertheless, the user can not configure other ways to display the subtitles.

Reference is made to FIG. 1 which shows a schematic diagram of a font display system for a DVD player. In the prior art, the font display system is applied to a DVD playback system which supports multiple subtitles. The figure shows a pickup head 102 of a DVD-Rom, and the pickup head 102 is used to detect the data in disk 101. Further, a processing unit 103 processes the data read out from the pickup head 102 and outputs the data as a video stream. Still further, a font memory 104 stores the font files of the multiple subtitles. When a font generating unit 105 receives the subtitle settings created by the user, the corresponding font stored in the font memory 104 is displayed. A control unit 106 controls the interactive signaling among the elements, such as the signaling received from the user's font configuration, access signaling to the font memory 104, and displayed font generated by the font generating unit 105.

Furthermore, the reference is made to U.S. Pat. No. 6,253,221 which describes a character display apparatus and a method for a DVD player. This reference provides a character display apparatus for the DVD player that detects the font data of a video, and separates the font data from the output video data signals. The font data is stored in a font memory, and the stored font data corresponds to a selected language and is outputted as subtitles. Reference is made to FIG. 2, which shows a block diagram of the embodiment of the character display apparatus of the prior art. Likewise, a pickup head 202 reads data from a disc 201, and outputs video data via the processing unit 203. The disc 201 stores multilingual data from the video. After that, a data separation section 204 separates the font data from the outputted video data signals. Meanwhile, a font dynamic memory 205 (RAM) is used to store the font data. Conventionally, a font ROM 206 stores default font data. Next, a character generating section 207 receives the font data outputted from the font dynamic memory 205 and the font ROM 206 and outputs the font data. Next, a control unit 208 performs a control command issued from the processing unit 203, and further controls the signal transmission among the elements. Moreover, the control unit 208 needs to determine whether or not the disc 201 stores the fonts. The font data is transferred to a font dynamic memory 205 and shows on the screen if the font exists in the disc 201. Meanwhile, the font stored in the font memory 206 is adopted by the system if the fonts do not exist in the disc 201.

According to the new-generation of DVD formats such as Blu-ray or high-density DVD (HD DVD), the font shown as the video subtitle can not only be the original font set by the disc, but also can be one of the font files chosen by the user, which are stored in the disc.

### SUMMARY OF THE INVENTION

An object of the present invention is to provide a font changing method for video subtitles. The method uses a video playback program, which may be implemented as software or embedded in a player machine, to provide a font-selection function for video subtitles. The font-selection function provides the user a flexible and customized subtitle, which is introduced to new-generation DVD formats, such as Blu-ray or HD DVD, having separated subtitle files. Therefore, no more measures need to be taken by the user to separate the video and its subtitles.

Blu-ray or high-density DVDs (HD DVDs) systems can have a disc format with separated video and subtitles. The video subtitle does not use a fixed font file stored in the disc as an image form. In the Blu-ray system, the font can be selected by the user. While Blu-ray or high-density DVDs (HD DVDs) can provide the fonts therein to be selected, the subject matter of the present invention further includes a user interface built into the playback program that allows a user to select the font in which subtitles are displayed. Therefore, the user can select a file with subtitle fonts from any accessible storage medium to be shown on the video.

As a video playback process starts, a playback program activates. The preferred embodiment of the present invention is to launch a video playback application which is installed in a computer system or embedded in a playback device. After launching the playback program, the activation process enters an initialization procedure. Next, the font changing method performs a step of reading data from a disc, and then retrieving a disc menu from the disc. After that, another step configures the subtitles and the font in which they are displayed. Next, a user interface becomes available to user to browse the font files stored in the storage medium, and then to select the desired font. Finally, the playback program joins the selected font with the subtitles, and combines the configured subtitles with the video streaming to be played.

The mentioned playback program is used to allow the user to control the hardware. The preferred embodiment of the font changing method provided by the present invention includes a first step of receiving a signal for activating the playback program. The method further includes a step of reading data from a disc. Next, the method retrieves the required information from the disc for an initialization process, and thereby determines a disc format. Since the disc has already been determined to support a disc format with separated video streaming and font files, the font for the subtitles can now be configured. The playback program then receives signals for configuring the subtitles and setting up the subtitles font, wherein the font files stored in the storage medium are accessed by means of browsing the font database. Next, the playback program receives a signal for selecting the subtitle font, and links to the selected font. After that, the playback program joins the font file and the video stream, and plays the video.

In particular, the above-mentioned storage medium can be a hard disk of a computer system, a portable storage device, or a network-based disk space, and is not restricted to the font files stored in the disc or the default fonts for the video.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a font displaying system for a DVD player of the prior art;

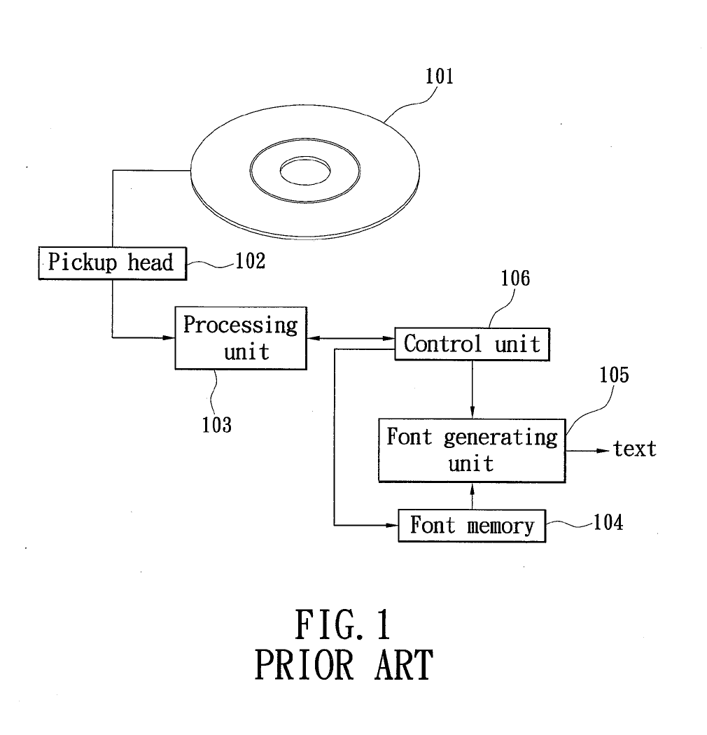

FIG. 2 shows another schematic diagram of the font displaying system of the DVD player in the prior art;

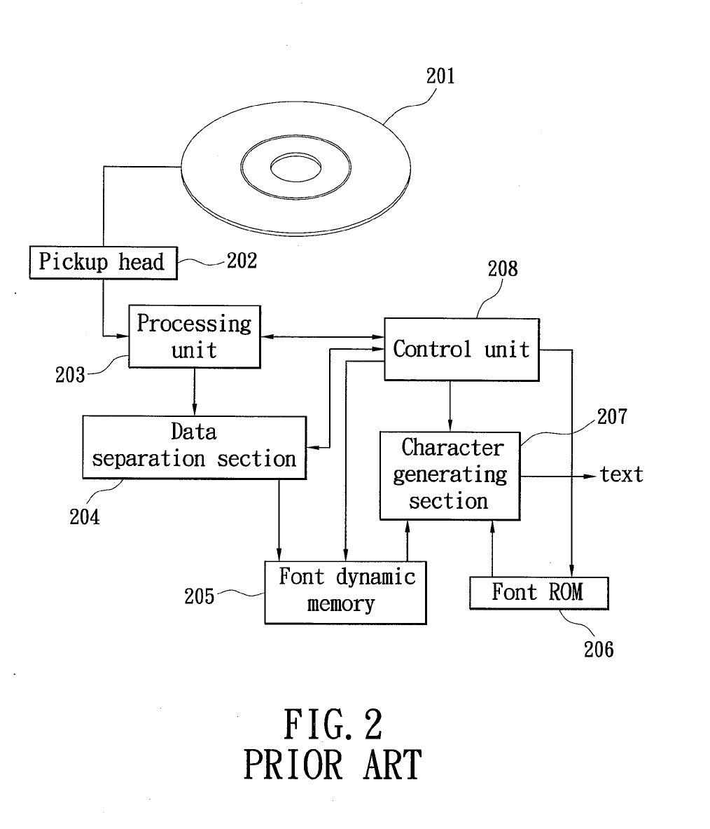

FIG. 3 shows a user interface for a playback program installed in a computer system;

FIG. 4 shows a playback program structure for subtitle font changing method of the present invention;

FIG. 5 is a flow chart of an embodiment of the method for changing subtitle fonts of the present invention;

FIG. 6 shows an operating flow of the playback program provided by the present invention.

### DETAILED DESCRIPTION OF THE PREFERRED EMBODIMENTS

The present invention is illustrated with a preferred embodiment and attached drawings. However, the invention is not intended to be limited thereby.

The present invention describes a font changing method for subtitles of a video by incorporating a video playback application in a computer, or a playback program embedded in a DVD player that allows the font of subtitles to be selected by the user. This font changing method offers a user greater flexibility to choose the settings for video subtitles. The method is applied to a disc format with a separated video streaming and font file, such as a Blu-ray disc system or a High-Density DVD.

For disc formats with separated video streaming and font files, the subtitles for the video are not shown in the font pattern stored in the disc. The font files are still provided in the disc for selection, but the present invention further introduces a user interface with font option items from a disc menu in a playback program. Particularly, the playback program can be implemented as a DVD playback application in a computer system or as a program embedded in a DVD player.

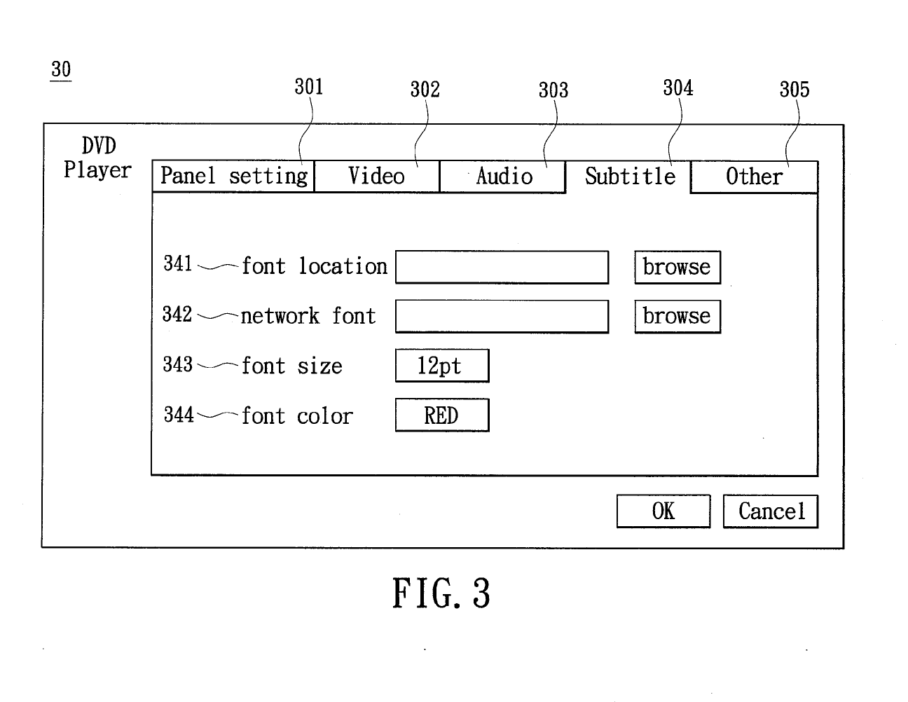

Reference is made to FIG. 3, which shows a schematic diagram of a user interface in a playback application in a computer system. A graphic-user-interface provided by a DVD playback application 30 is shown. The option items provided by the application 30 include at least one panel setting 301 for changing the interface appearance of the playback application 30. The option items further include video settings 302 that relate to playing the video, configuring the screen proportion, the color, the contrast, and so on. The option items further include audio settings 303 for changing the output channel, output speakers, output effects (stereo, Dolby Surround, and so on), and language. The option items further include subtitle settings 304 for setting up the option to show or not show subtitles, the language to be shown on the screen or at the subtitle position. The option items further provide some other configurations 305. In addition, the practical implementations are not limited to the above-mentioned items.

Moreover, the mentioned settings options are provided in some conventional playback programs. A font-selecting function in the font changing method of the present invention is further introduced. In the preferred embodiment of the present invention, the subtitle settings 304 further include a function for selecting the location of font files, such as the option item of a font location 341 shown in the diagram. The option item of the font location 341 allows a user to select the font file stored in the disc, and also the font files stored in another storage medium. The storage medium can be a removable storage medium such as a hard disk or a portable disk drive. Furthermore, a network-based disk space can embody the storage medium by incorporating the item of a network font 342, whereby the font files stored in a local area network space can be selected as the font for the video subtitles. After the font file has been selected, further settings can include font size 343, font color 344, and other options such as bold, italic, superscript, subscript or underlined font. The practical embodiments are not limited to the shown graphic user interface. Furthermore, a preview window can be provided to preview the fonts to allow the user to adjust the font-related configurations. The mentioned storage medium for the font changing method can also be a hard disk, a portable disk drive or other removable storage devices such as a network-based disk space.

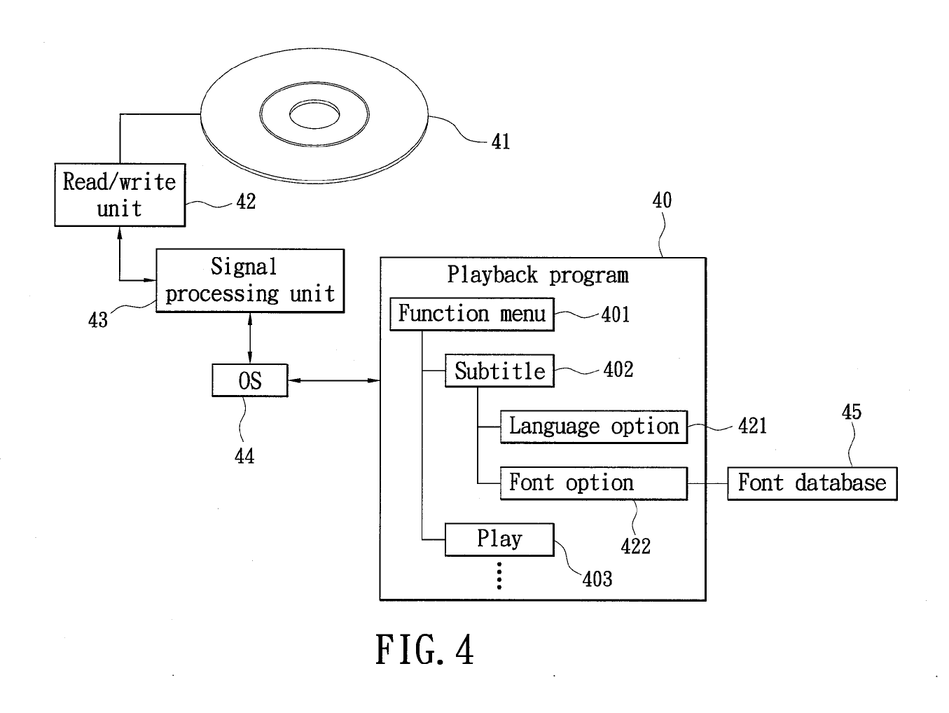

FIG. 4 shows a block diagram depicting the playback program used to achieve the object of the font changing method of the present invention. The playback program 40 can be implemented as a software application or be embedded into the DVD player in the preferred embodiment. Thus, the playback program 40 receives the control command from the user and then performs signal transmission via the operating system 44 and the playback hardware such as a computer or a DVD player. Next, a signal processing unit 43 performs the signal processing which has a read/write unit 42 reading data from a disc 41 and processing other playing actions, such as forward, backward, fast forward/backward, slow forward/backward, stop or pause, according to the signal transmitted from the control signals. Next, the read/write unit 42 transmits the video content or other responding signals to the operating system 44 through the signal processing unit 43. After that, the playback program 40 installed in the operating system 44 transmits the signals and produces the configurations for the video, and then plays the video.

The playback program 40 includes a plurality of function options, wherein a function menu 401 is included and includes at least a subtitle option 402 and a play button 403. The subtitle option 402 of the present invention includes at least a language option 421 and a font option 422. The font option 422 specifically links to a font database 45. Thereby the user can use the font option 422 to select a font file stored in the font database 45. Therefore, the font shown on the video is not limited to what is stored on the disc. The font database 45 can include the font files stored in any kind of storage medium mentioned above, such as the files on a hard disk, or the files on a portable disk drive, or the files stored on a network-based disk space.

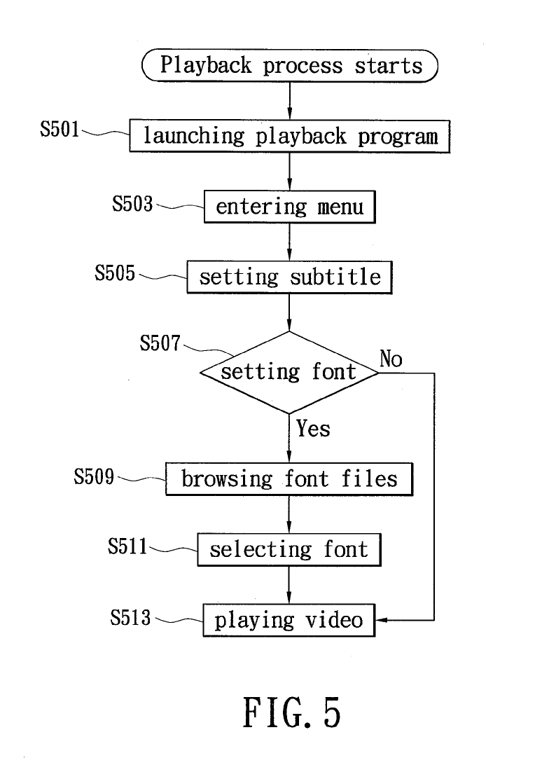

The font changing method of the present invention uses the playback program packaged as a software application or embedded in the DVD player to provide a font selection function for the video subtitle. The playback program performs signal transmission via the operating system and related hardware. The preferred embodiment of the present invention is applied to a disc format with separated video streaming and subtitle data, and the steps are shown in FIG. 5 as follows:

When playing the video, the first step launches the playback application or the playback program embedded in the player. In one of the preferred embodiments, the playback application installed in the computer system is launched. In another embodiment, the step turns on an audio/video playing device and enters a boot-up initialization process (step S501).

After launching the playback program, the program reads the data from a disc and enters a provided disc menu (step S503). The disc menu has a plurality of settings items, wherein the present invention is applied to select the font in a subtitle option. More, the disc specifically supports a disc format with separated video streaming and subtitle data.

The next step configures the subtitles in the disc menu (step S505). Both the functions of configuring the subtitles and the fonts are provided (step S507). If the user does not set up the font, step S513 in which the playback program plays the video directly with a default subtitle font is selected.

If the user wants to change the font, a user interface is incorporated for browsing the font files stored in the storage medium (step S509). A font file can then be selected (step S511). Next, the playback program joins the selected font with the video. After that, the playback program starts playing the video upon the user's command (step S513).

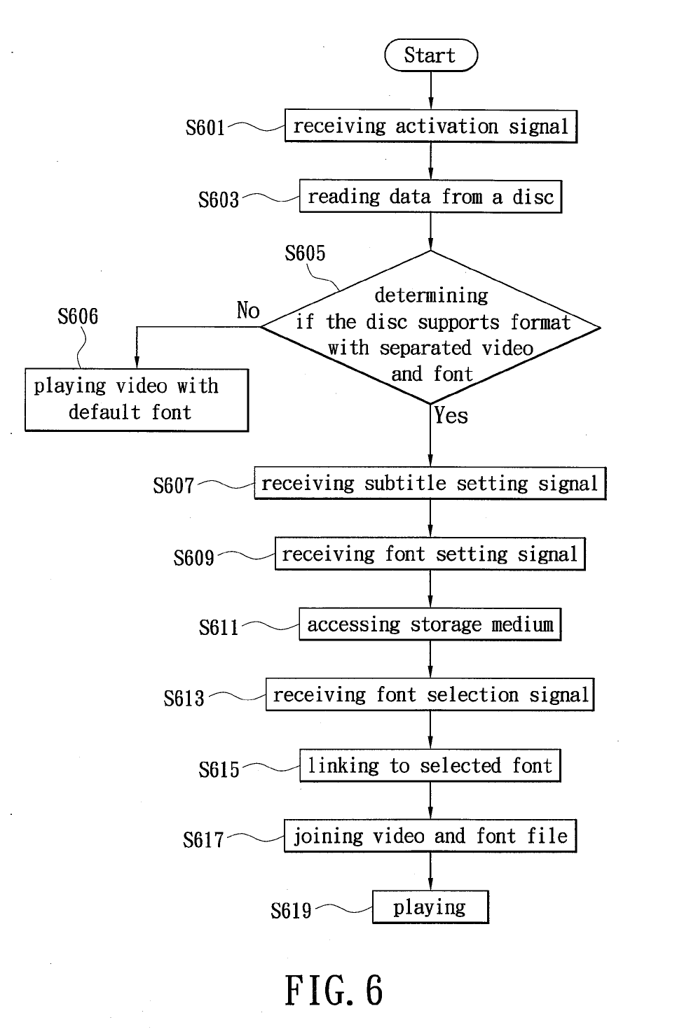

The playback program is introduced into the font changing method for subtitles for a video of the present invention. A graphic-user-interface is incorporated in the preferred embodiment for allowing users to browse the font files stored in the storage medium and configuring the font for the subtitles. The font for the subtitles can be configured easily and offers users a wide selection of fonts for the subtitles. As the playback program receives the control signal based upon the user's command, the hardware performs the command, transmits the audio/video content and also provides a playback environment. FIG. 6 shows the flow of the signal transmission between the playback program and the operating system.

At first, the operating system receives a signal for activating the playback program; namely the user launches this playback program by sending a command through the operating system, then the operating system produces the activation signal (step S601). After activating the playback program, the playback program reads data from a disc and retrieves the required information for performing an initialization process (step S603). The retrieved information is used to determine whether the disc supports the format capable of configuring the font for video subtitles (step S605). If the disc does not support this format, the playback program plays the video in a default manner (step S606).

Since the font changing method of the present invention is applicable to disc formats with separated video streaming and subtitle data, specifically for Blu-ray DVDs and HD DVDs, the method provides a plurality of steps to configure the font for subtitles before playing the video. The steps include configuring the font for the subtitles if the disc is determined to support separated video streaming and subtitle data. After that, the playback program receives a signal for configuring the subtitles from the user who uses the program to select the settings (step S607). Next, the playback program receives a signal for setting up the font (step S609). Alternatively, if the disc in-use doesn't support the applicable format, the step plays the video with the default font in a conventional process (step S606).

Since the playback program allows users to browse the font database, the users can browse the font files stored in the font database thereby. When receiving the signal for font configuration, the playback program accesses the storage medium (step S611), and further receives the signal for font selection (step S613).

According to the signal for font selection, a specific font file is selected as the subtitle font which the playback program links to (step S615). After that, the playback program joins the video and the font file in step S617, and then plays the video in step S619.

In summation of the description above, the font changing method for video subtitles of the present invention selects the subtitle font by incorporating a playback program. The playback program joins the selected font in a storage medium with video streaming, and plays the video. The object of the present invention is to provide users with the ability to select a desired font for video subtitles.

While the invention has been described by means of a specification with accompanying drawings of specific embodiments, numerous modifications and variations could be made thereto by those skilled in the art without departing from the scope and spirit of the invention set forth in the claims.

What is claimed is:

1. A font changing method for subtitles of a video, wherein a user interface is introduced to allow a font for a video subtitle to be changed, and the video and the font are two separated files, comprising:
reading data from a disc;
retrieving a disc menu from the disc;
setting up a font option item for the subtitle from the menu;
introducing the user interface to browse font files from a storage medium;
selecting one of the font files; and
joining the font file and the video.

2. The font changing method of claim 1, wherein the user interface is provided by a playback program.

3. The font changing method of claim 2, wherein the playback program is a packaged disc playback application.

4. The font changing method of claim 2, wherein the playback program is a playing program embedded in a video player.

5. The font changing method of claim 1, wherein the disc supports a playback format with separated video and font files.

6. The font changing method of claim 1, wherein before the step of setting up the font option item, the method further comprising a step of determining whether or not the disc supports the format with separated the video streaming and subtitle data.

7. The font changing method of claim 5, wherein a Blu-ray DVD embodies the disc.

8. The font changing method of claim 5, wherein a High-Density DVD embodies the disc.

9. The font changing method of claim 2, wherein an operating system and a playback device are utilized to process signals while the playback program is being configured.

10. The font changing method of claim 1, wherein a hard disk embodies the storage medium.

11. The font changing method of claim 1, wherein the storage medium is a network-based disk space.

12. The font changing method of claim 1, wherein the storage medium is removable.

13. A font changing method for subtitles of a video, wherein a playback program is introduced to provide a font selection function for changing the font of subtitles, comprising:
receiving a signal for activating the playback program;
reading data from a disc that supports a disc format with separated video streaming and font file;
receiving a signal for setting up the subtitle font;
accessing a storage medium that includes a font database;
receiving a signal for selecting the subtitle font;
linking to a file with the selected subtitle font; and
joining the video streaming and the font file.

14. The font changing method of claim 13, wherein the method adopts a graphic-user-interface to browse the font files stored in the storage medium.

15. The font changing method of claim 13, wherein the playback program is a packaged disc playback application.

16. The font changing method of claim 13, wherein the playback program is embedded in a player.

17. The font changing method of claim 13, wherein at the step of reading data from the disc, the method further comprising:
determining whether or not the disc supports a format with separated video streaming and subtitles font files.

18. The font changing method of claim 13, wherein the disc is a Blu-ray DVD.

19. The font changing method of claim 13, wherein the disc is a High-Density DVD.

20. The font changing method of claim 13, wherein the playback program processes signals through an operating system and a video playback device.

21. The font changing method of claim 13, wherein a hard disk embodies the storage medium.

22. The font changing method of claim 13, wherein a network-based disk space embodies the storage medium.

23. The font changing method of claim 13, wherein the storage medium is removable.
